(19) United States
(12) Patent Application Publication
(10) Pub. No.: US 2015/0213117 A1
(43) Pub. Date: Jul. 30, 2015

(54) ADAPTIVE UI FOR NESTED DATA CATEGORIES ACROSS BROWSER VIEWPORTS

(71) Applicant: Microsoft Corporation, Redmond, WA (US)

(72) Inventors: Matthew Bailie, Seattle, WA (US); Brandon Morton, Redmond, WA (US); Annice Jumani, Seattle, WA (US); Ping Lu, Seattle, WA (US)

(73) Assignee: Microsoft Corporation, Redmond, WA (US)

(21) Appl. No.: 14/164,170

(22) Filed: Jan. 25, 2014

(51) Int. Cl. G06F 17/30; H04L 29/08; G06F 3/0484; G06F 17/22; G06F 3/0485

(52) U.S. Cl. CPC G06F 17/30643; G06F 17/2247; G06F 3/0485; G06F 3/0484; H04L 67/10

(57) ABSTRACT

Systems and methods of downloading and rendering data from a server or other source on a user's computer system wherein the data is a set of nested data categories are disclosed. The set of nested data categories further comprise a set of active logic levels where the set of active logic levels may be dynamically changed, depending on the size of the browser that the user of the computer system may set. In one embodiment, the user's computer system has a desktop or laptop sized screen upon which to render data. If the user resizes the browser to be substantially the size of a mobile screen, then the present system may dynamically adjust the logic levels (e.g., changing the number of click targets within the browser) to better facilitate a scrolling experience within the browser.

### BACKGROUND

Traditional User Interfaces (UI) for categorizing data in responsive environments typically only support one level of nesting. In addition, nesting categorized data controls may cause a UI experience that may be confusing for the user. An adaptive UI for nested data categories may ameliorate some of the potential confusion that may also be easily understood by the user.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Systems and methods of downloading and rendering data from a server or other source on a user's computer system wherein the data is a set of nested data categories are disclosed. The set of nested data categories further comprise a set of active logic levels where the set of active logic levels may be dynamically changed, depending on the size of the browser that the user of the computer system may set. In one embodiment, the user's computer system has a desktop or laptop sized screen upon which to render data. If the user resizes the browser to be substantially the size of a mobile screen, then the present system may dynamically adjust the logic levels (e.g., changing the number of click targets within the browser) to better facilitate a scrolling experience within the browser.

In one embodiment, a method for implementing an adaptive UI for rendering a set of nested data categories across a plurality of browser viewports, the method comprises: inputting a set of nested data categories, said set of nested data categories capable of being rendered in a browser for a user of a computer system; detecting the viewport of the browser in which said set of nested data categories are to be rendered; if the viewport is less than a desired size, then rendering said set of nested data categories with desired labels as mobile data categories; if the viewport is greater or equal than a desired size, then rendering said set of nested data categories with desired labels as data categories for the desired larger screen size; and if the browser is resized to another screen size data category, rendering said set of nested data categories as appropriate for said resized screen.

In another embodiment, a computer system comprises: a processor; a computer readable memory, said computer readable memory capable of storing computer readable data and instructions; a communications component, said communications component capable of receiving a set of nested data categories from a second computer system external to said computer system; a screen, said screen capable of rendering data and displaying said data to a user of said computer system; a set of UI components, said set of UI components capable of being used by said user to interact with said data rendered on said screen; and a browser, said browser capable of being resized into one of a plurality of viewports and rendering said set of nested data categories according to the current viewport of said browser.

In yet another embodiment, a method for rendering data on a computer system from a webpage within a browser, said data from a webpage comprising a set of nested data categories, said set of nested data categories further comprising a set of nested logic levels capable of being activated by a user, the method comprises: requesting a set of nested data categories from a webpage hosted on a server, the server remote from said computer system; downloading said set of nested data categories from the webpage; depending on the viewport of the browser running on the computer system, setting the nested logic levels of the nested data categories according to the viewport.

Other features and aspects of the present system are presented below in the Detailed Description when read in connection with the drawings presented within this application.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 depicts one exemplary environment in which present systems, methods and/or techniques may reside, as made in accordance with the principles of the present application.

FIG. 2 shows one embodiment of an exemplary computer system that may run and/or host the methods and/or techniques of the present application.

FIGS. 3, 4 and 5 depict the dynamic behavior of an adaptive UI with nested data categories across a number of browser viewports.

FIGS. 6A and 6B depicts one embodiment of a lifecycle process of an adaptive UI as made in accordance with the principles of the present application.

### DETAILED DESCRIPTION

As utilized herein, terms “component,” “system,” “interface,” “controller” and the like are intended to refer to a computer-related entity, either hardware, software (e.g., in execution), and/or firmware. For example, any of these terms can be a process running on a processor, a processor, an object, an executable, a program, and/or a computer. By way of illustration, both an application running on a server and the server can be a component and/or controller. One or more components/controllers can reside within a process and a component/controller can be localized on one computer and/or distributed between two or more computers.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

### Exemplary Environment

In many embodiments of the present systems and methods, adaptive UIs for nested data categories may reside and be implemented in a number of places—either singly or in combination—within a variety of typical computing and networking environments. For example, such adaptive UIs may reside on a single computing device or may reside on a server that is connected to various computing devices via a wired or wireless network.

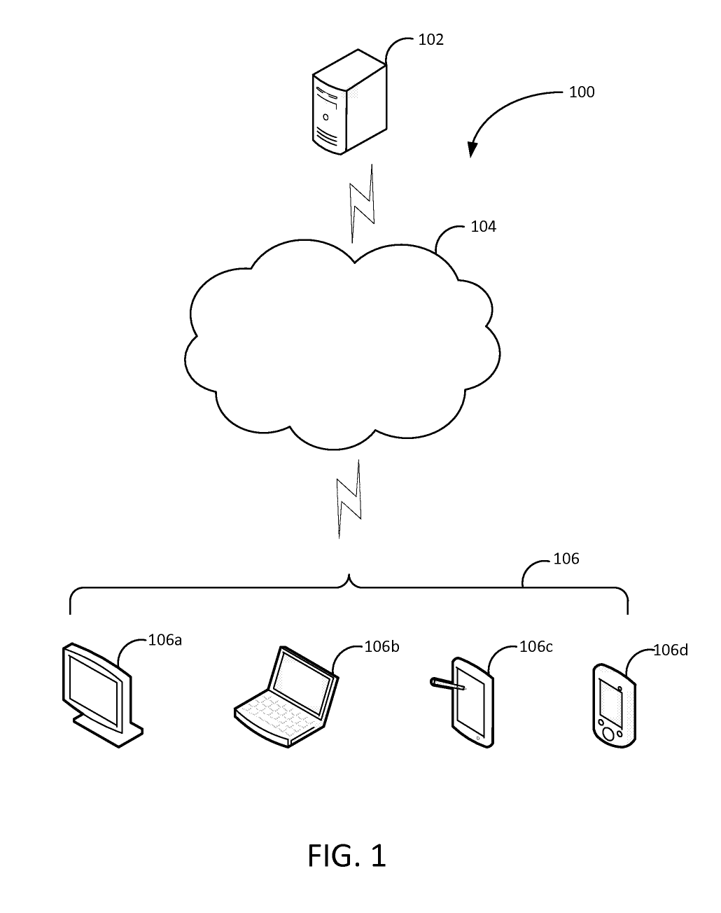

FIG. 1 is one exemplary environment (100) in which the present systems and techniques of the present application may reside and/or be implemented. As mentioned, the present systems and/or methods may reside on a server 102 that may affect the adaptive UI (as disclosed herein) via a network 104 (e.g. Internet or other networking configuration) to one or more client computers 106. Computers 106 may comprise any possible computing device; and more particularly, two different computing devices have different display screen sizes (upon which various data/metadata may be rendered—e.g., webpages having data/metadata formatted for a particular screen size). For example, computing devices 106 may comprise desktop 106a, laptop 106b, tablet 106c and/or smart device/phone 106d.

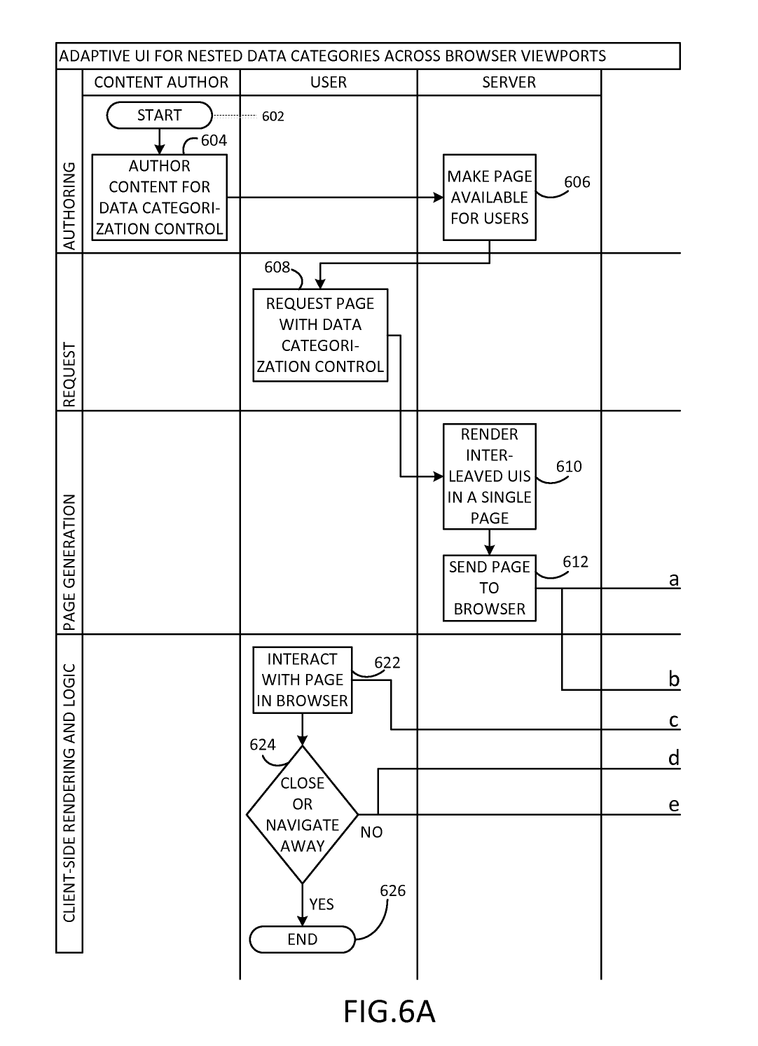

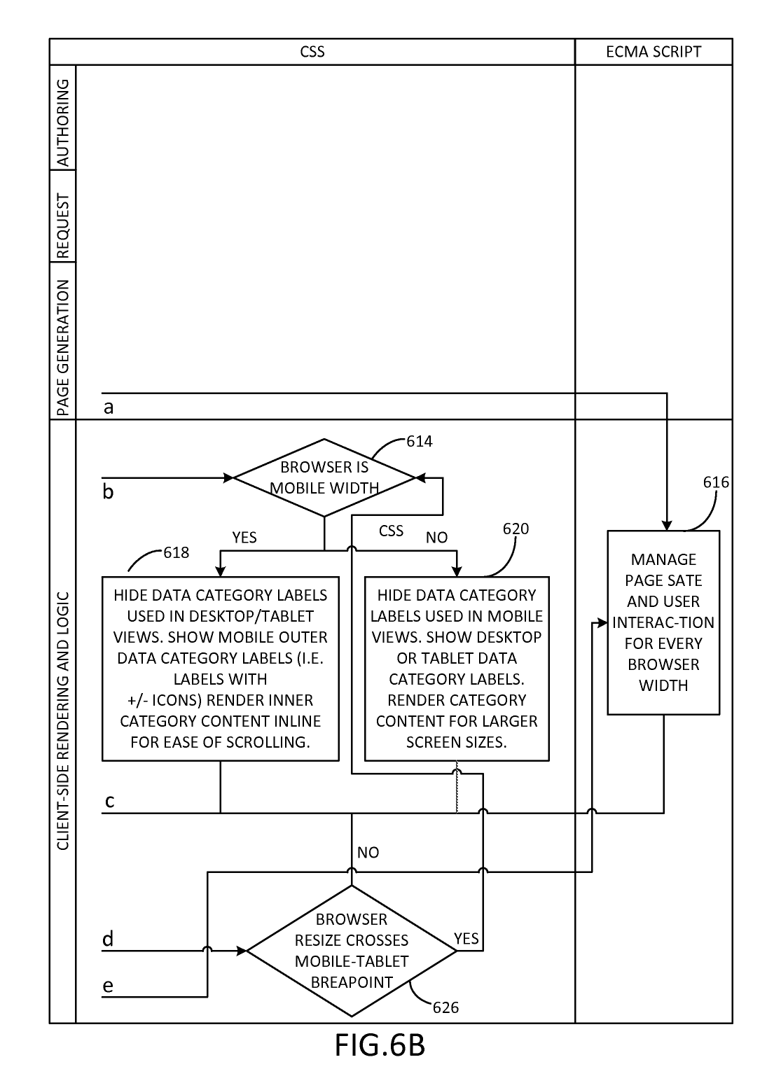

In one embodiment, the server may render enough markup to support any screen size (e.g., as in step 610 in FIG. 6A, as discussed further herein), and a rendering decision may be made on the device via a combination of CSS and JavaScript (e.g., for handling various states at steps 614 et seq.). For this embodiment, it may suffice that the only communication between device and server is for the page request and response (e.g., as in steps 608-612).

In a different embodiment, it may be possible that a device may communicate (e.g., via any known protocol) to server and indicate to server what display screen size the device may have. In such a case, server may affect an adaptive UI experience to the user of the device, possibly depending upon what the user of the device may do in order to structure data within a browser that may be re-sized upon the display screen.

For one exemplary event, a user on a desktop may resize a browser to another viewport—e.g., increase the viewport to utilize the full screen of the desktop. But, in another case, the user may desire to shrink the browser/viewport to a smaller size (e.g., the size approximating a laptop screen size, tablet size and/or smart device size) in order to arrange the user's view of the various other information windows and/or viewports on the display screen. A common example might be the user has a browser open on the display screen; but may desire to dynamically resize the browser—e.g., so as to view other information such as a word processing document to work concurrently while viewing the browser.

As mentioned, the systems and methods of the present application may be used in other than a client-server setting—e.g., as on an individual computing devices. The present systems may reside in the operating system, applications, or in another part of the computing device.

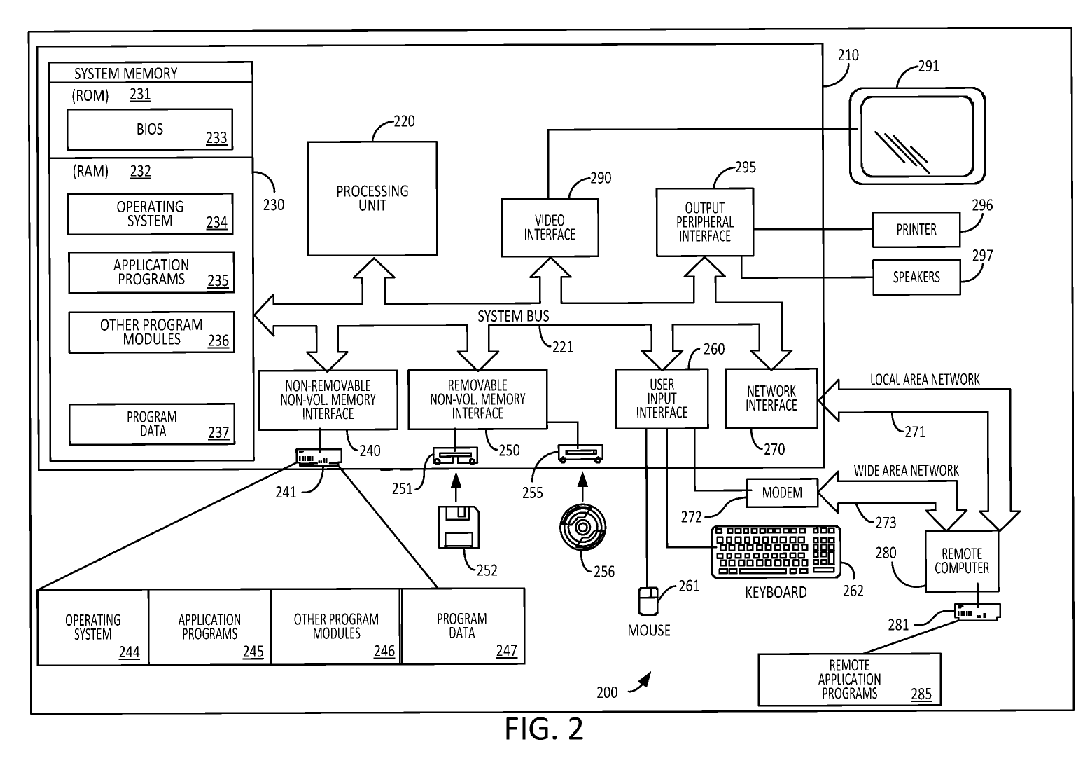

FIG. 2 illustrates an example of a suitable computing system environment 200 in which the present systems and/or methods may be implemented, in whole or in part on, e.g., computers 106 (106a, 106b, 106c and/or 106d). The computing system environment 200 is only one example of a suitable computing environment and is not intended to suggest any limitation as to the scope of use or functionality of the present application. Neither should the computing environment 200 be interpreted as having any dependency or requirement relating to any one or combination of components illustrated in the exemplary operating environment 200.

The present systems/methods may be operational with numerous other general purpose or special purpose computing system environments or configurations. Examples of well-known computing systems, environments, and/or configurations that may be suitable for use with the present application include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The present application may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing the present system/method may comprise a general purpose computing device in the form of a computer 210. Components of computer 210 may include, but are not limited to, a processing unit 220, a system memory 230, and a system bus 221 that couples various system components including the system memory to the processing unit 220. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237.

The computer 210 may also include other removable/non-removable, volatile/nonvolatile computer storage media. By way of example only, FIG. 2 illustrates a hard disk drive 241 that reads from or writes to non-removable, nonvolatile magnetic media, a magnetic disk drive 251 that reads from or writes to a removable, nonvolatile magnetic disk 252, and an optical disk drive 255 that reads from or writes to a removable, nonvolatile optical disk 256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules and other data for the computer 210. In FIG. 2, for example, hard disk drive 241 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a keyboard 262 and pointing device 261, commonly referred to as a mouse, trackball or touch pad. Other input devices (not shown) may include a microphone, joystick, game pad, satellite dish, scanner, or the like. These and other input devices are often connected to the processing unit 220 through a user input interface 260 that is coupled to the system bus, but may be connected by other interface and bus structures, such as a parallel port, game port or a universal serial bus (USB). A monitor 291 or other type of display device is also connected to the system bus 221 via an interface, such as a video interface 290. In addition to the monitor, computers may also include other peripheral output devices such as speakers 297 and printer 296, which may be connected through an output peripheral interface 295.

The computer 210 may operate in a networked environment using logical connections to one or more remote computers, such as a remote computer 280. The remote computer 280 may be a personal computer, a server, a router, a network PC, a peer device or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks. Such networking environments are commonplace in offices, enterprise-wide computer networks, intranets and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device. By way of example, and not limitation, FIG. 2 illustrates remote application programs 285 as residing on memory device 281. It will be appreciated that the network connections shown are exemplary and other means of establishing a communications link between the computers may be used.

### Overview of Adaptive UI Environments

For the present expository purposes, the adaptive UI will now be described in the context of responsive tab control—e.g., such as may be found on responsive web designs that may be employed by websites or other portals. This context is merely used for the purposes of exposition and is not meant to limit the application of the present systems, methods and/or techniques of the present application.

Broadly speaking, modern tab control has two supported variants—horizontal and vertical. For one example (as is known in the art), a horizontal tab control may comprise different parts: a title, area for tabs and, possibly a dropdown menu. These parts may typically be displayed horizontally across a display screen and is capable of being interactive with the user. A typical vertical tab control may comprise a title and an area for tabs. In this example, the area for tabs may be displayed underneath the title and may be capable being interactive with the user. If one theme in the area for tabs is activated, then there may be another column displayed which may have content that is germane or associated with the theme.

### One Embodiment of Adaptive UI For Nested Data Categories Across Browser Viewports

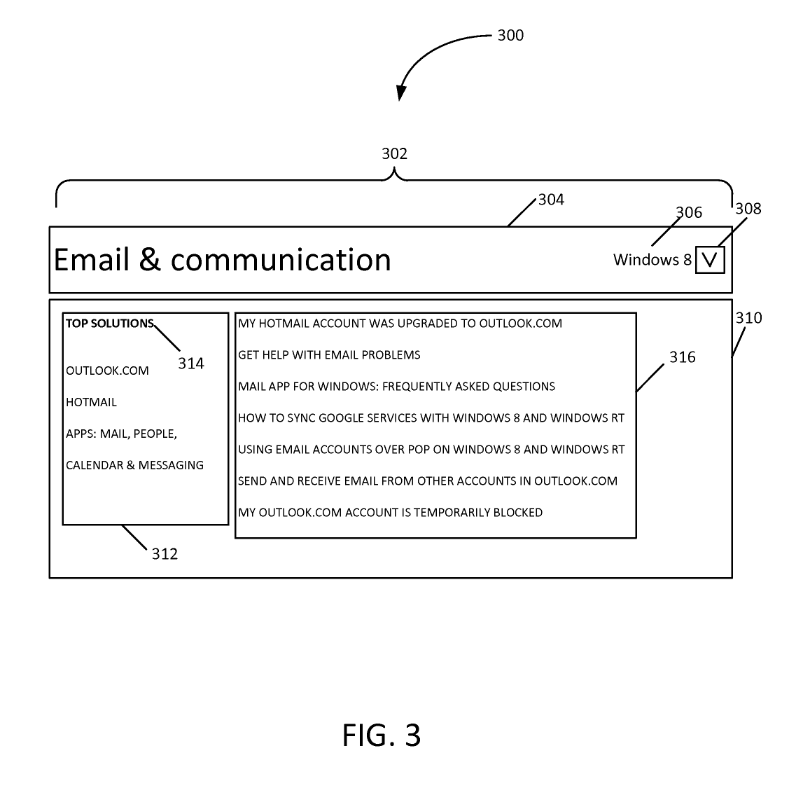

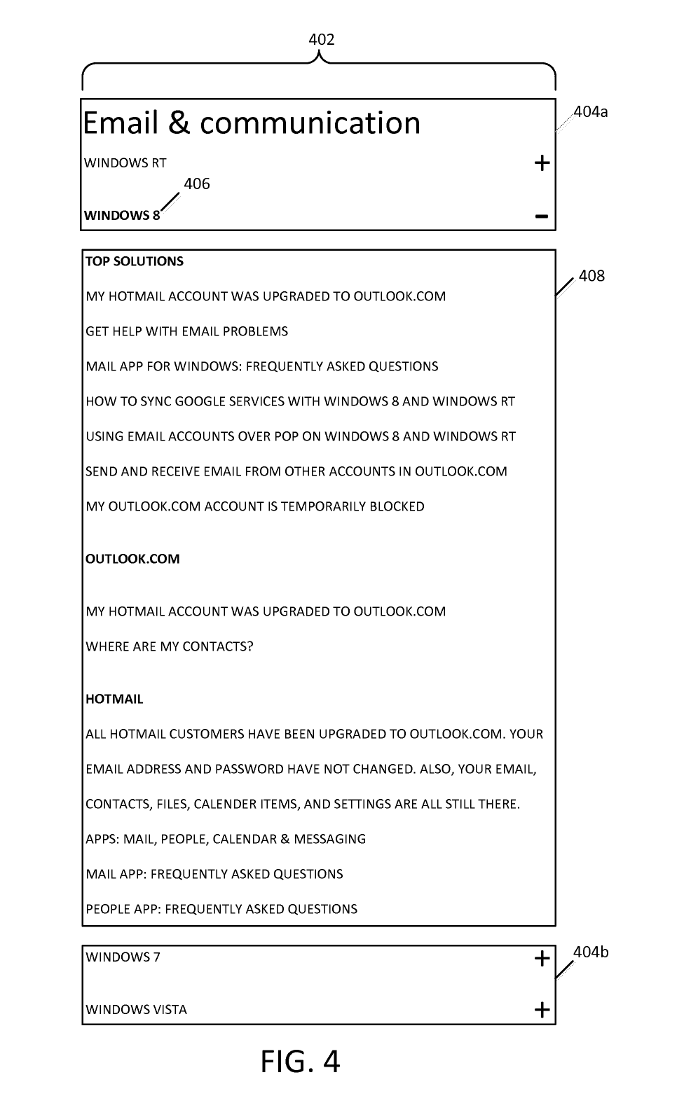

One embodiment of the present application will now be discussed in the context of the FIGS. 3, 4 and 5. In one embodiment, the adaptive UI comprising a nested data categorization control may change its interaction model for switching between data categories and content layout—e.g., based on the size of the viewport. FIGS. 3 and 4 depict such an embodiment and provide details about how the nested UI may adapt based on viewport size.

In many embodiments, the adaptive UI may receive or otherwise input a set of nested data categories. For example, the set of nested data categories may represent a set of subject matter related data (e.g., as seen here in the figures, data that may relate to different operating systems). In addition, the set of nested data categories may be nested to multiple (e.g., two or more) levels of logic—e.g., wherein different level may have click targets for the browser or otherwise functional logic with which the user may interact.

In one aspect (and as will be seen), the data categorization control of the present application may adapt its UI based on whether it renders inside of another data categorization control. In one embodiment, it may be possible that the adaptation may be made by the content author—and may not be automatically determined by the code. In another embodiment, the adaptation may be automatically determined by the code and/or system. The control also adapts its UI based on browser viewport size. In addition, nested data categorization control adapts UI based on viewport size by changing the click targets into headings, which are displayed as part of content.

FIG. 3 depicts one exemplary browser view (300) for an adaptive UI as made in accordance of the principles of the present application—e.g., for which it may be intended to operate for a responsive website. Merely for exemplary purposes, browser view 300 may be displayed in a certain viewport size 302 as shown. This particular viewport may be displayed on a screen appropriate for a desktop and/or laptop—but may not be appropriate for display on smaller screens—e.g., smart phones or the like.

At viewport size 302, there may be seen an outer data categorization control 304—in which there may be a selected outer data category 306 (e.g., possibly with a dropdown menu to select other categories). In this example, the title is “Email & Communication” and the selected outer data category 306 may comprise a set of operating systems. For example, Windows© Version 8 operating system is depicted as being selected—and the dropdown menu 308 may be used to select other (non-selected) operating systems. With the outer data category 306 being selected, associated outer data category content 310 is also shown.

In this embodiment, nested data categorization control may render with a categorization control—which may have a selected category and unselected categories. The nested control also may have an area for presenting the content of the selected nested category. When the user selects a nested data category, the content of that category may be presented in the area for nested category content.

For example, in FIG. 3, within the associated outer data category content 310, nested data categories 312 are provided—and one such nested data category 314 (e.g., “TOP SOLUTIONS”) is shown as being selected. Other, non-selected, nested data categories are also depicted (e.g., OUTLOOK.COM, HOTMAIL, APPS, MAIL, PEOPLE, and CALENDAR & MESSAGING). Together with the selected data category 314, selected nested data category content 316 is also displayed. As may be appreciated, selection of another nested data category may tend to display its own associated nested data category content.

As will now be depicted, the data categorization control adapts its UI based on whether it renders inside of another data categorization control. As before, this adaptation may be a content authoring decision or, alternatively, determined by the system. The control also adapts its UI based on browser viewport size.

For example, in FIG. 4, the particular content of FIG. 3 may appear different—e.g., when rendered on a smaller screen (or if resized on a larger screen) to have a viewport size 402. In this embodiment, if the browser view is so resized to a smaller viewport 402, then the content and/or functionality may change as desired (e.g., becomes a click target). For example, options in list 306 may be click targets in both FIGS. 3 and 4. Options in list 312 may be click targets in FIG. 3, but may become non-click-targets in FIG. 4. Thus, the resizing of the browser view may also change the clickable status of content with the browser view—e.g., from clickable to non-clickable or vice versa.

FIG. 4 shows outer data categories 404a and 404b displayed on the screen. One such outer data category 406 (e.g., Windows© 8 version operating system) is selected. At viewport size 402, the nested data categorization control adapts the UI. The categorization control may be removed—along with the ability to select different data categories. The titles of the data categories may now be rendered as headings in the content of the particular category—as shown as selected outer data category content 408.

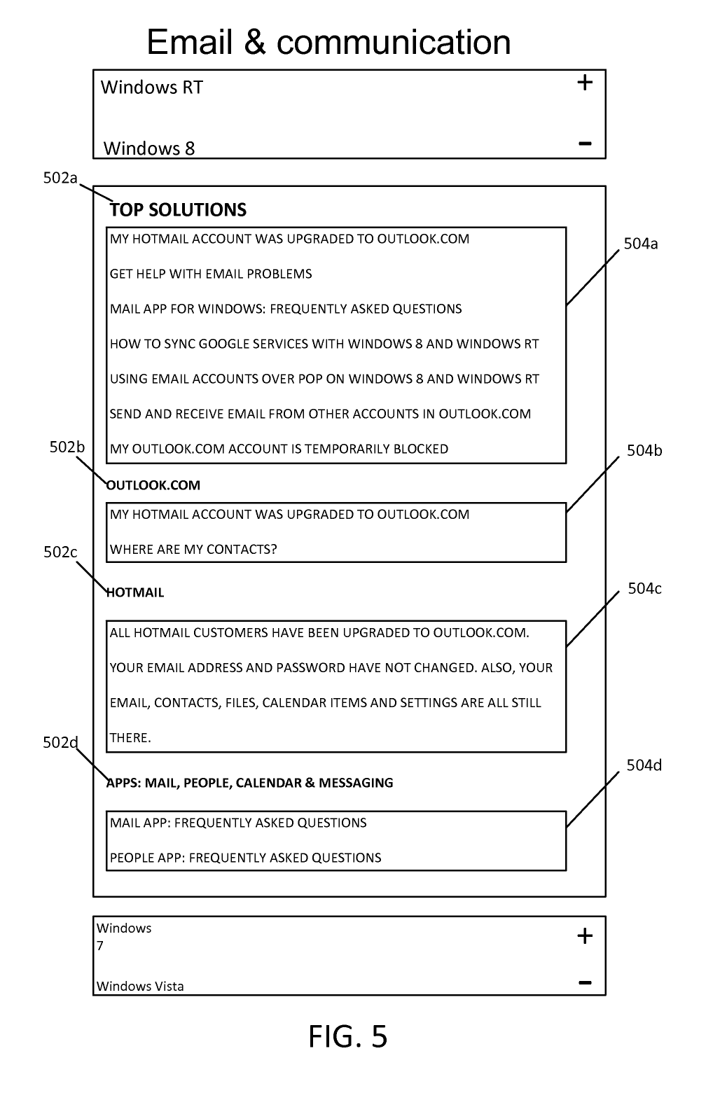

FIG. 5 shows the browser view of FIG. 4—and depicts the set of selected outer data category content 408 as fully selectable and functional (e.g., may become a click target of the like). For example, in one embodiment, content 502a, 502b, 502c and 502d may be possibly non-clickable themselves; however, they may comprise potentially selectable content 504a, 504b, 504c and 504d. As may be seen in the transition from FIG. 3 to FIGS. 4 and 5, the levels of nested logic may be dynamically changed—e.g., in order to provide ease to the user for scrolling through data on a browser sized for a mobile viewport and/or screen.

### Lifecycle for Adaptive UI for Nested Data Categories Across Browser Viewports

FIGS. 6A and 6B depict several embodiments of methods and/or techniques for affecting such an adaptive UI as made in accordance with the principles of the present application. FIGS. 6A and 6B depict one lifecycle embodiment—as represented by the various stages of implementation. For example, FIGS. 6A and 6B depict the following stages: authoring, requesting, page generation, and client-side rendering and logic. It will be appreciated that each of these stages may represent different and independent aspects of the present application—and that the scope of the present application is not limited to this lifestyle in its entirety. Indeed, for merely one example, client-side rendering methods are not dependent upon any particular authoring, requesting, and/or page generation method and/or technique. Similarly, other methods are likewise not dependent on other parts of the entire lifecycle.

Starting at 602, the lifecycle of an adaptive UI starts with an author creating content for the data categorization control as depicted above (at 604). Once authored as desired, the webpages (or other software employing such adaptive UI) may be made available at a server for users (at 606).

Over time, users may request the page comprising the data categorization control (at 608). Once so requested the server may render the appropriated interleaved UI in a single page (at 610) and the server may then send the page (at 612) to the user's browser (or other application requesting such adaptive UI). At all times, the process may seek to manage page usage and user interaction appropriately for all possible browser widths and/or sizes at 616.

At the user, the computer may inquire as to, or otherwise detect, (at 614) the size of the viewport upon which the browser may be rendered. For example, the computer system may inquire/detect whether the viewport is sized to be mobile device width. In one embodiment, the viewport may be dynamically resized by the user via known UI components (e.g., a mouse, a keyboard, a touch screen or the like). Alternatively, the computer may inquire/detect a setting made by the server downloading the set of nested data to the user's computer system. In yet another alternative, the viewport may be dynamically resized by other applications that may be running on the user's computer system (possibly, e.g., if suitable permissions are granted to such other applications).

If so, then the computer system may hide data category labels used in desktop and/or tablet view (at 618). In addition, the computer system may show outer data category labels (e.g., ones with a “+” or “−” icons, or the like). The computer system may render inner category content inline for ease of scrolling—e.g., on a mobile device or one a browser with a viewport sized for mobile viewing. In one embodiment, the logic of some of the category content may be changed in this case to become active, functional and/or a click target—or vice versa. Dynamically varying the logic and/or levels of logic in this manner may be desirable for a user who is using (or emulating) a mobile device and desires to scroll and interact with the data in a more timely fashion. In such a case, the number of visible categories may be increased—e.g., to improve the user experience of scrolling on a mobile device and/or in a mobile browser viewport.

It will be appreciated that the processing for rendering the nested data categories and selecting what data may be active and/or functional (e.g., become a click target) may reside at various points within the exemplary environment (e.g., as noted in FIG. 1 above). For example, such processing may reside in the server, the client or possibly both server and client in order to affect the desired functionality of the nested data presented to the user.

If not, then the computer system may hide data category labels used in mobile views (at 620). In addition, the computer system may show desktop or tablet data category labels and render category content for larger screen sizes.

At this point, the user may interact with the page in the browser at 622. If the user is finished, then the adaptive UI may terminate or otherwise close or navigate away at 624 and end at 626. However, it may be the case that the user (or other application) may resize the browser—and to the extent that the new size may cross a boundary point—for example, the mobile/tablet boundary point. Crossing this boundary may return the adaptive UI to point 614 within the process and inquire if the browser is fit for mobile width and the process may continue until the adaptive UI is closed and/or navigated away.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A method for implementing an adaptive UI for rendering a set of nested data categories across a plurality of browser viewports, the method comprising:
inputting a set of nested data categories, said set of nested data categories capable of being rendered in a browser for a user of a computer system;
detecting the viewport of the browser in which said set of nested data categories are to be rendered;
if the viewport is less than a desired size, then rendering said set of nested data categories with desired labels as mobile data categories;
if the viewport is greater or equal than a desired size, then rendering said set of nested data categories with desired labels as data categories for the desired larger screen size; and
if the browser is resized to another screen size data category, rendering said set of nested data categories as appropriate for said resized screen.

2. The method of claim 1 wherein said set of nested data categories comprise a set of subject matter related data.

3. The method of claim 1 wherein said set of nested data categories comprise a set of a plurality of logic in which the user may interact.

4. The method of claim 1 wherein detecting the viewport of the browser further comprises detecting the resizing of the viewport by the user via the UI components of the computer system.

5. The method of claim 1 wherein detecting the viewport of the browser further comprises one of a group, said group comprising: detecting a user's sizing of the browser and detecting a setting from a server from which said set of nested data categories are downloaded.

6. The method of claim 1 wherein detecting the viewport of the browser further comprises detecting the resizing of the viewport by an application running on user's computer system.

7. The method of claim 1 wherein rendering said set of nested data categories with desired labels as mobile data categories further comprises rendering inner category content inline for ease of scrolling.

8. The method of claim 7 wherein rendering inner category content inline further comprises changing the clickable status of inner category content.

9. The method of claim 1 wherein rendering said set of nested data categories with desired labels as data categories for the desired larger screen size further comprises rendering desktop or tablet data category labels.

10. The method of claim 1 wherein said method further comprises changing the logic of the nested levels to a desired level of functionality for the user.

11. A computer system comprising:
a processor;
a computer readable memory, said computer readable memory capable of storing computer readable data and instructions;
a communications component, said communications component capable of receiving a set of nested data categories from a second computer system external to said computer system;
a screen, said screen capable of rendering data and displaying said data to a user of said computer system;
a set of UI components, said set of UI components capable of being used by said user to interact with said data rendered on said screen; and
a browser, said browser capable of being resized into one of a plurality of viewports and rendering said set of nested data categories according to the current viewport of said browser.

12. The system of claim 11 wherein said communication component further capable of communicating with a server, said communication component receiving data from a webpage.

13. The system of claim 12 wherein said data received from a webpage comprises a set of nested data categories.

14. The system of claim 13 wherein said browser is further capable of being resized by said user using one of said set of UI components; and
further wherein said if the viewport of said browser is decreased to a mobile viewport, then said logic of said nested data categories is capable to be changed to be functional logic.

15. The system of claim 14 wherein said logic of said nested data categories is capable of having its clickable status changed within said browser.

16. The system of claim 15 wherein said nested data categories is capable of being scrolled in said browser by said user.

17. The system of claim 11 wherein said viewport is capable of being resized into one of a group, said group comprising: a mobile viewport, a laptop viewport, a desktop viewport.

18. A method for rendering data on a computer system from a webpage within a browser, said data from a webpage comprising a set of nested data categories, said set of nested data categories further comprising a set of nested logic levels capable of being activated by a user, the method comprising:
requesting a set of nested data categories from a webpage hosted on a server, the server remote from said computer system;
downloading said set of nested data categories from the webpage;
depending on the viewport of the browser running on the computer system, setting the nested logic levels of the nested data categories according to the viewport.

19. The method of claim 18 wherein setting the nested logic levels of the nested data categories according to the viewport further comprises dynamically changing the number of click targets in said nested data categories if the viewport of the browser is a mobile viewport.

20. The method of claim 19 wherein the method further comprises allowing the user to scroll through an increased number of visible categories.
